(19) United States
(12) Patent Application Publication
(10) Pub. No.: US 2019/0284826 A1
(43) Pub. Date: Sep. 19, 2019

(54) DEVICE FOR SWIMMING POOL SKIMMING AND FILTERING

(71) Applicant: Xiaoyu Gu, Cypress, TX (US)

(72) Inventor: Xiaoyu Gu, Cypress, TX (US)

(73) Assignee: Xiaoyu Gu, Cypress, TX (US)

(21) Appl. No.: 15/924,238

(22) Filed: Mar. 18, 2018

(51) Int. Cl. E04H 4/12; C02F 1/00; B01D 39/14; B01D 29/31

(52) U.S. Cl. CPC E04H 4/1272; C02F 1/001; C02F 2103/42; B01D 29/31; B01D 39/14

(57) ABSTRACT

A filtration device for swimming pool cleaning system combines a filter and a skimmer together as a one unit. The device is made from a perforated plastics or steel tube spirally-wrapped with a sheet of filter media such as non-woven fabric or cloth or other soft and porous materials for multiple layers. The filter media such as non-woven fabric or cloth or other soft and porous materials is washable, reusable, and disposable. This device is placed and installed at the same location as for the normal swimming pool skimmer where the water is pumped from the pool into its cleaning system. This device has a large opening on the bottom, and the opening is blocked by use of a plug. This device has a transparent top cover plate. This device is capable of not only blocking and removing large leaves and debris, but also blocking and removing micro-size fine particles as water flows through. This device is simple, small, light in weight, and cheap to make.

### BACKGROUND

Commercial or residual swimming pool cleaning system includes a water pump, skimmers, filters, pipes, etc., as shown in FIG. 1. As water is pumped by a water pump from the pool, leaves and debris are first blocked and removed by skimmers. Water then goes through a filter or filters to further block and remove fine particles before it returns to the pool. There are several types of filters such as sand filters, cartridge filters, and D.E. (diatomaceous earth) filters. Sand filters are large tanks filled with pool filter sand, which is 0.45-0.55 mm in size. Sand filters remove particles as low as 20 microns which are caught in the tiny grains of sand. Eventually, the particles build up inside the tank blocking the water from pushing through. This raises the pressure inside the filter tank. When the filter has too much pressure, it requires backwash to flush out the filter by reversing the water flow out the backwash/waste port on a multiport valve. Cartridge filters are large tanks that house a cartridge filter or filters. Filter media such as non-woven fabric screens or cloths are used to remove particles as low as 10 microns. Because of the large surface area, it has less resistance and performs well at slower speeds. Eventually, the particles build up on cartridge filter media which blocks the water from pushing through. To remove the particles built up on filter media, cartridge filters need to be removed out from the tank and sprayed down with a garden hose to remove particles. Over the time, the filter cartridges wear out and need to be replaced. For large pools, it would require multiple large filter cartridges. When large filter cartridges are saturated with water, they become very heavy. To maintain these large filter cartridges can be a real problem. D.E. (Diatomaceous earth) filters use a powdered form of fossilized exoskeletons to remove particles as low as 5 microns. They are large tanks with grids or fingers that are coated with the D.E. Powder, which performs like sand, but better. D.E. filters are more expensive and require more maintenance work.

All types of swimming pool filters share the same drawback that require extensive maintenance work which in many times is beyond average people's capability. Swimming pool filtration equipment are expensive, heavy, bulky, and complicated. Current cartridge filter has only one single layer of filter media which is not effective to remove fine particles. It wears quickly. Though harder filter media is used to improve the life, it reduces its porosity, and thus restrains water flow, resulting in high pressure built up. Filter media such as non-woven fabric is often pleated to increase the contact surface with water and to increase its strength. Because of the complicated shapes of pleated filter media folded each other, it is difficult to clean and remove the trapped particles especially at those locations at two ends of the cartridge. Consequently, there is a need to have a simple, low-cost, highly-efficient filtration device which requires a little maintenance work that can be easily performed by average people.

Alternatively, a filtration device as disclosed here is to be used for swimming pool water filtration system. This device is extremely simple, cheap, small, light in weight, highly-efficient in filtration to remove micro-size fine particles. Most importantly, it is not required to have specialists to perform extensive maintenance work. Filter media is cheap, and it is washable, reusable, and disposable. It can be easily replaced with fresh new filter media without opening a large complicated tank as it is required for the cartridge filters and D.E. filters. Thus, it requires a little maintenance work which can be easily performed by average people.

### BRIEF DESCRIPTION

It is here disclosed a filtration device which combines a filter and a skimmer together as a one unit. This device is served for the purposes of blocking and removing leaves and debris. And, it is also served for the purposes of blocking and removing micro-size fine particles. This device is simple, low-cost, small, light in weight, highly-efficient in filtration to remove micro-size fine particles. Most importantly, it requires a little maintenance work. Filter media is cheap, and it is washable, reusable, and disposable. It can be easily replaced with fresh new filter media without opening a large complicated tank as it is required for the cartridge filters and D.E. filters. Therefore, it requires a little maintenance work which is easily performed by average people.

This filtration device as disclosed here combines a filter and a skimmer together as a one unit. With reference to FIG. 2, this device consists of a commonly-used skimmer basket A, and a filter cartridge B and C. The filter cartridge is made from a perforated plastics tube B spirally-wrapped with a sheet of filter media C for at least one revolution or at least five revolutions or at least 10 revolutions. The filter cartridge is installed inside the skimmer basket which has a bottom plug D and covered with a top plate E. There are two handlers F attached on the top plate. This device is placed at the same location as the normal swimming pool skimmer without making any changes of existing setup. This device is served not only as a skimmer to block and remove large leaves and debris, but also served as a filter to block and remove micro-size fine particles. The filter media is such a kind of material of soft, flexible, porous, loft, etc. One example of such a kind of material is non-woven fabric or cloth, which is capable of blocking particles at specific range of particle size.

### BRIEF DESCRIPTION OF THE DRAWINGS

The following descriptions should not be considered limiting in any way. With reference to the accompanying drawings, like elements are numbered alike:

FIG. 1 shows a general cleaning system for a swimming pool;

FIG. 2 shows a filter device as disclosed here which combines a skimmer and a filter together as a one unit;

FIG. 3 shows a filter cartridge that a sheet of filter media such as non-woven fabric or cloth is spirally-wrapped on a perforated plastic tube for multiple layers;

FIG. 4 shows a filter device which consists of a filter cartridge, a bottom plug, a bottom plate, a swimming pool skimmer basket, and a top plate; FIG. 4 is referred in the example;

FIG. 5 shows the particle size and distribution chart for the #1 slurry;

FIG. 6 shows the particle size and distribution chart for the #2 slurry;

FIG. 7 shows the particle size and distribution chart for the #3 slurry;

FIG. 8 shows the particle size and distribution chart for the #4 slurry;

FIG. 9 shows the particle size and distribution chart for the #5 slurry.

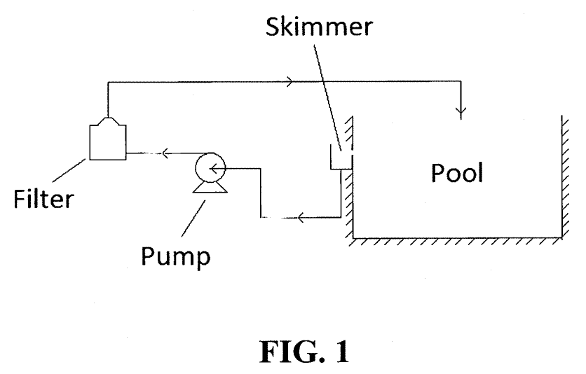

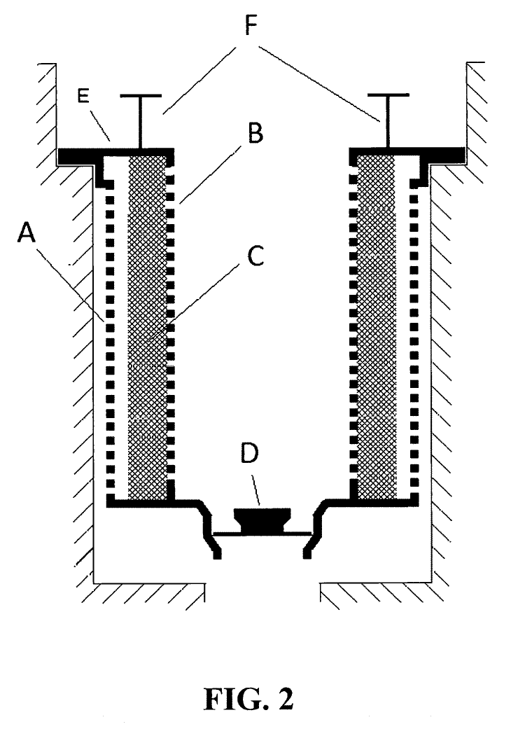

TABLE 1 shows a summary of the particle size and distribution data.

### DETAILED DESCRIPTION

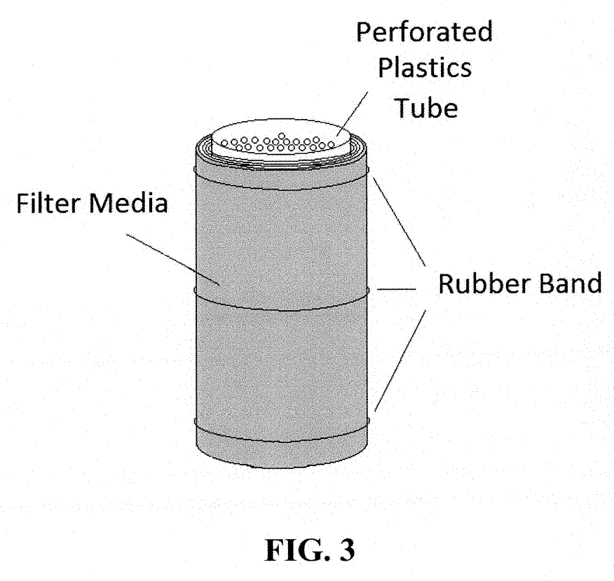

Disclosed herein is a swimming pool filtration device which combines a filter and a skimmer together as a one unit. This device consists of a commonly-used skimmer basket and a filter cartridge. The filter cartridge as shown in FIG. 3 is made from a perforated plastic tube spirally-wrapped with a sheet of filter media such as non-woven fabric or cloth or other soft and porous materials for at least one revolution or at least five revolutions or at least 10 revolutions. The filter cartridge is installed inside the skimmer basket and covered with a top plate. This device is placed at the same location as the normal swimming pool skimmer without making any changes of existing setup. This device is served not only as a skimmer to block and remove large leaves and debris, but also served as a filter to block and remove micro-size fine particles. The filter media is such a kind of material as an example of non-woven fabric, or cloth, which can block specific range of particle sizes. Filter media is cheap, and it is washable, reusable, and disposable.

The filter cartridge is made from a perforated plastics tube spirally-wrapped with a sheet of filter media such as non-woven fabric or cloth or other soft and porous materials. One end of the perforated plastics tube is plugged by use of a rubber stopper. One example of such a rubber stopper is the flange and plug used for home garbage disposal. The garbage disposal flange is bonded on one end of the perforated plastics tube by use of epoxy adhesive. A round-shape plastics plate is cut with the outside diameter as the same as the bottom inside diameter of a normal swimming pool skimmer basket. This round-shape plastics plate is also cut with a center hole at the same diameter as the outside diameter of the perforated plastics tube. By use of epoxy adhesive, the round-shape plastics plate and the perforated plastics tube are bonded together. The filter cartridge which consists of a perforated plastics tube, spirally-wrapped filter media on the perforated plastics tube, garbage disposal flange and a rubber stopper, and a round-shape plastics plate is placed inside a swimming pool skimmer basket. Another round-shape plastics plate or cover plate is cut with the outside diameter as the same as the top outside diameter of the swimming pool skimmer basket. This round-shape plastics plate or cover plate is also cut with a center hole at the same diameter as the inside diameter of the perforated plastics pipe. By use of screws and nuts, the cover plate, the swimming pool skimmer basket, and filter cartridge are joined together.

The device which consists of a filter cartridge, a swimming pool skimmer basket, a cover plate is installed and placed at the same location as a normal swimming pool skimmer where the water is pumped from the pool to the pool cleaning system. When water flows through the device, not only the large leaves and debris are blocked and removed, but the micro-size fine particles are blocked and removed from the water.

A pair of handlers is attached on top of the cover plate by use of screws. Once a week or once for a couple of weeks, the device is pulled out by lifting the handlers. After the bottom plug is removed, device is cleaned by spraying water down with a garden hose to remove large leaves and debris. After removing top screws and nuts, top cover plate is removed from the device. The filter cartridge is then removed from the swimming pool skimmer basket. Un-wrapped and removed from the perforated plastics pipe, filter media such as a sheet of non-woven fabric or cloth is cleaned and washed in a bucket of water. After removing trapped micro-size fine particles or dirties, the filter media such as a sheet of non-woven fabric or cloth is spirally-wrapped on the perforated plastics tube. Alternatively, a fresh new filter media such as a sheet of non-woven fabric or cloth is used and installed on the device. The filter media such as non-woven fabrics is commercially available under the name of white felt from the Hobby Lobby store (SKU: 728287) at low price (supplied as a roll at the width of 72 inches for $5.99/yard).

It is desired that the top plastics cover plate is made from a transparent polycarbonate plate or other types of transparent plates. Such one example of the transparent polycarbonate sheet having the thickness about 0.125 inches is commercially available at the Home Depot store (SKU #1000118443). Because of the transparency of the top cover plate, one can see the degree of the filtration by observing the color changes of the white felt from the original white color to brown or dark color as fabric traps more particles and dirties.

Because the filter device is made from multiple layers of filter media such as non-woven fabric or cloth spirally-wrapped on the perforated plastics tube, its filtration effectiveness to remove micro-size fine particles is greatly increased in comparison with single-layer filter cartridge.

### EXAMPLE

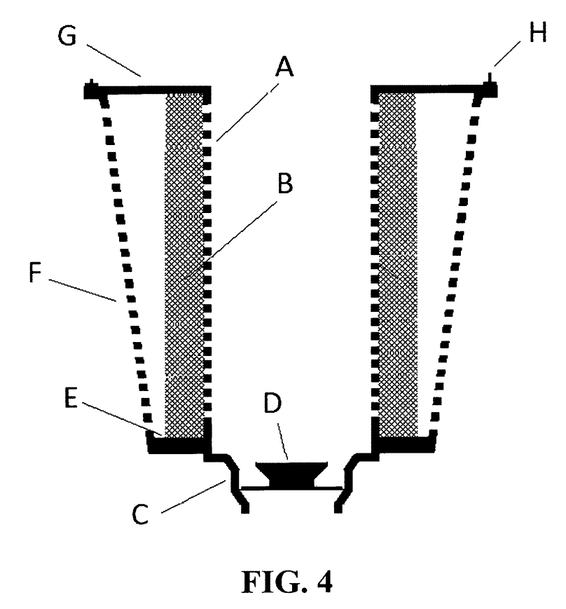

As shown in FIG. 4, a piece of PVC plastics tube A having outside diameter 4.5 inches and inside diameter 4 inches which is commercially available from the Home Depot store (pipe size 4 inches Schedule 40, SKU #295112) is cut at the size of 5 inches in length. This PVC pipe is drilled with many holes having the diameter about 0.25 inches throughout the surface. The distance between two adjacent holes is about 0.25 inches. A piece of non-woven fabric or white felt B which is commercially available from the Hobby Lobby store (SKU: 728287) is cut at the size of 5 inches in width and 75 inches in length. This non-woven fabric is spirally-wrapped on the perforated PVC tube. Three pieces of rubber bands are used to secure the non-woven fabric in place. A garbage disposal flange C is bonded on one end of the perforated PVC tube by use of epoxy adhesive. A garbage disposal rubber stopper D is used to block the opening of garbage disposal flange. A round-shape transparent polycarbonate plate E having outside diameter 5.6 inches and inside diameter 4 inches and thickness 0.125 inches is cut by use of a CNC router which is commercially available from the Rockier Companies, Inc. (item #: 53189). Transparent polycarbonate plate is commercially available from the Home Depot store (SKU #1000118443). The round-shape transparent polycarbonate plate having outside diameter 5.6 inches and inside diameter 4 inches and thickness 0.125 inches is bonded on the garbage disposal flange by use of epoxy adhesive. The filter cartridge which consists of a perforated plastics tube A spirally-wrapped with a white non-woven fabric B, a garbage disposal flange C, a garbage disposal rubber stopper D, and a round-shape transparent polycarbonate plate E, is placed inside a commonly-used swimming pool skimmer basket F which is commercially available from the Leslies Poolmart Inc. (SKU #: R38008). A round-shape transparent polycarbonate cover plate G having outside diameter 8.125 inches and inside diameter 4 inches and thickness 0.125 inches is cut. 8 pieces of ANSI #8 screws and nuts H are used to join the transparent polycarbonate cover plate and swimming pool skimmer basket together. For design of the commercial product of such a filtration device as disclosed here, it is desired to have special screws called as D-sub knurled thumb screws to connect cover plate and swimming pool skimmer basket together because the cover plate is often being removed for the purpose of cleaning and is often being installed for the purpose of re-use. D-sub knurled thumb screws are often used for computer cable connection and disconnection without a screw driver. D-sub knurled thumb screws are also retainable, which reduces the possibility that screws are got lost.

The filtration device as shown in FIG. 4 is installed and placed at the same location as a normal swimming pool skimmer where the water is pumped from the pool to the pool cleaning system. After the pool cleaning system runs for 3 days total for 72 hours, the filtration device is pulled out from the pool. After removing the rubber stopper D, the leaves and debris are removed from the filtration device by spraying the water by use of a garden hose. After removing the top cover plate G, the filter cartridge is removed from the skimmer basket F. The non-woven fabric B is un-wrapped from the perforated plastics tube A. Because significant number of particles and dirties are trapped, the color of the non-woven fabric changes from original white to brown and dark. The non-woven fabric which is 75 inches in length and 5 inches in width is cut into 5 pieces, and each piece is 15 inches in length and 5 inches in width. The first piece from the cutting is the first layer wrapped on the perforated plastics tube, which is assigned as #1; the second piece from the cutting is the second layer wrapped on the perforated plastics tube, which is assigned as #2; the third piece from the cutting is the third layer wrapped on the perforated plastics tube, which is assigned as #3; the forth piece from the cutting is the forth layer wrapped on the perforated plastics tube, which is assigned as #4; the fifth piece from the cutting is the fifth layer wrapped on the perforated plastics tube, which is assigned as #5. The #5 piece is the outside layer, or the final layer of the non-woven fabric spirally-wrapped on the perforated plastics tube. Each of the 5 pieces of non-woven fabric is placed inside a plastics cup which is filled with distilled water. After vigorously stirring, particles and dirties which are trapped on the non-woven fabric are separated from the non-woven fabric and dispersed in the water as slurry. Particle size and distribution for each of the slurry labeled as #1, #2, #3, #4, and #5 are measured by use of an instrument called as particle size analyzer Mastersizer 3000. This instrument is capable of measuring particle size ranging from 0.01 microns to 3500 microns. It is commercially available from companies such as Malvern Panalytical.

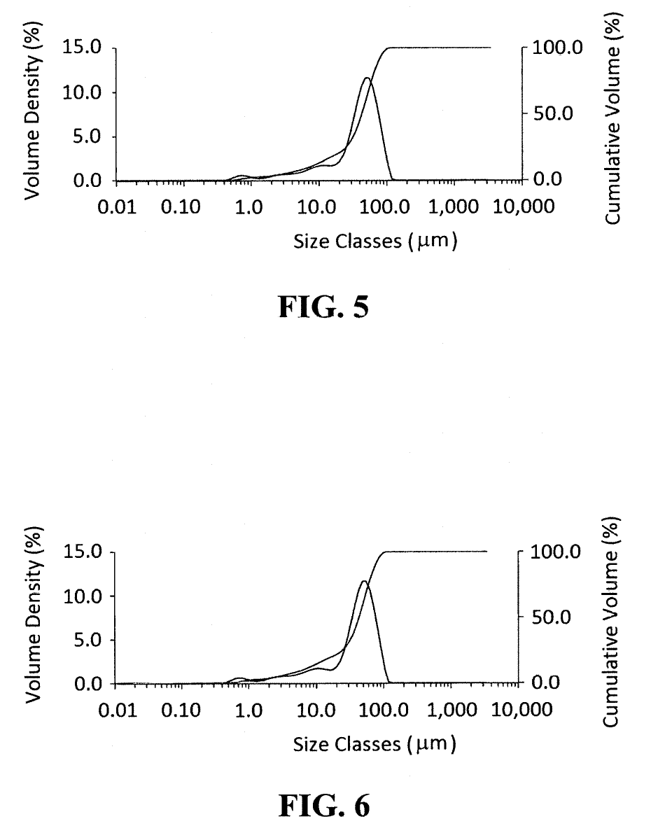

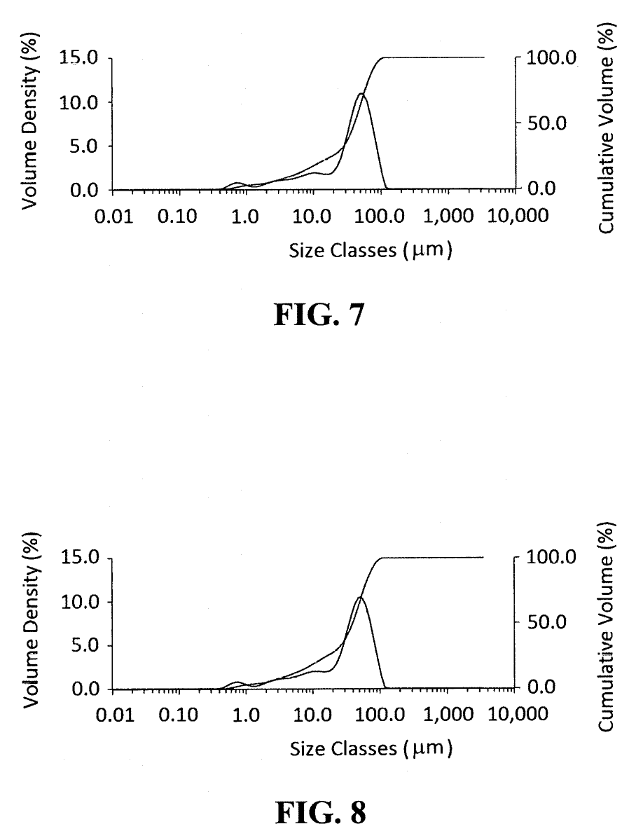

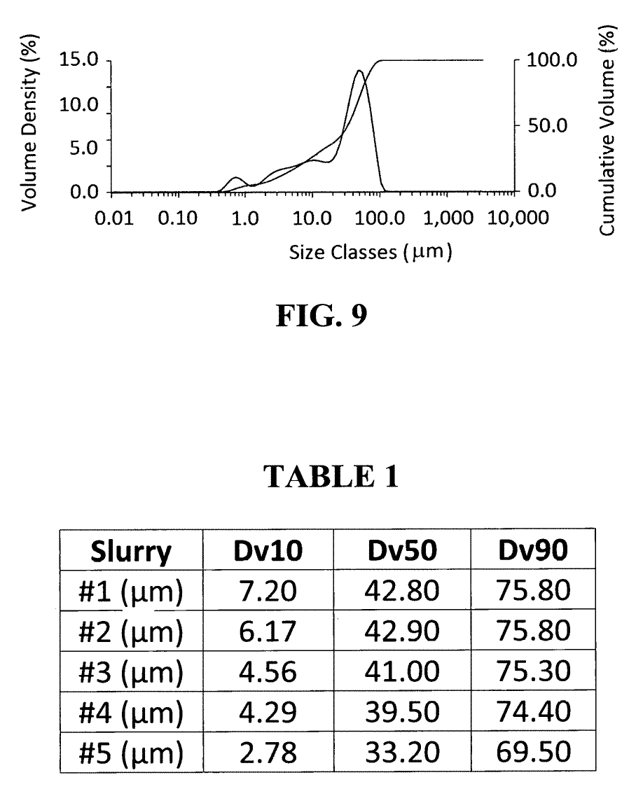

FIG. 5 shows the particle size and distribution chart for the #1 slurry, the first layer of non-woven fabric wrapped on the perforated plastics tube; and FIG. 6 shows the particle size and distribution chart for the #2 slurry; FIG. 7 shows the particle size and distribution chart for the #3 slurry; FIG. 8 shows the particle size and distribution chart for the #4 slurry; FIG. 9 shows the particle size and distribution chart for the #5 slurry, the outside layer or the final layer of the non-woven fabric spirally-wrapped on the perforated plastics tube. TABLE 1 shows a summary of particle size distributions for 5 samples of slurry. The Dv10 in the TABLE 1 is the diameter at which 10% of the sample's volume is comprised of particles with a diameter less than this value. The Dv50 in the TABLE 1 is the diameter of the particle that 50% of a sample's volume is smaller than and 50% of a sample's volume is larger than. Based on the particle size and distribution charts, it is concluded that the filtration device as disclosed here by spirally-wrapping multiple layers of non-woven fabric is capable of blocking and trapping fine particles as small size as 0.4 micron or larger. As the filtration device continues in use, clarity of water in the pool improves significantly.

What is claimed is:

1. A filtration device for swimming pool cleaning system:
a filtration device which combines a filter and a skimmer together as a one unit.

2. The device of claim 1, wherein the filter is made from a perforated plastics tube or a perforated steel tube or other type of perforated tube spirally-wrapped with a sheet of filter media such as non-woven fabric or cloth or other soft and porous materials for at least one revolution or at least five revolutions or at least 10 revolutions.

3. The filter media such as non-woven fabric or cloth or other soft and porous materials is washable, reusable, and disposable.

4. The device of claim 1 is placed and installed at the same location as for the normal swimming pool skimmer where the water is pumped from the pool into the cleaning system.

5. The device of claim 1 has a large opening on the bottom, and the opening is blocked by use of a rubber plug or any other kind of plug.

6. The device of claim 1 has a transparent top cover plate, and the cover plate is connected to other components by use of D-sub thumb screws or clips.

7. The device of claim 1 is capable of blocking and removing large leaves and debris as water flows through.

8. The device of claim 1 is capable of blocking and removing micro-size fine particles as water flows through.

9. The device of claim 1 is simple, small, light in weight, and cheap to make.
